(19) United States
(12) Patent Application Publication
(10) Pub. No.: US 2026/0162388 A1
(43) Pub. Date: Jun. 11, 2026

(54) METHOD AND SYSTEM OF RENDERING A 3D IMAGE FOR AUTOMATED EAR MORPHING

(71) Applicant: MATHEW POWERS, NEW YORK, NY (US)

(72) Inventor: MATHEW POWERS, NEW YORK, NY (US)

(21) Appl. No.: 18/235,329

(22) Filed: Aug. 17, 2023

Related U.S. Application Data
(60) Provisional application No. 63/398,687, filed on Aug. 17, 2022.

(51) Int. Cl. G06T 19/20; G06T 3/40; G06V 40/16

(52) U.S. Cl. CPC G06T 19/20; G06T 3/40; G06V 40/161; G06T 2219/004

(57) ABSTRACT

A computerized method useful for rendering a 3D image for automated ear morphing comprising: obtaining a face image, wherein the face image comprises a digital image of a view of a user's ears; detecting whether an ear in the digital image of a view of a user's ears is covered or not covered with a classifier; annotating a data side images of the digital image of the view of a user's ears; building a model to detect the ear beginning with a plurality of plurality of 2D landmarks of the user in the digital image; transferring the plurality of 2D landmarks of the user to a 3D model of the user; using a FLAME functionality to fit on the ear to the 3D model of the user; and morphing the ears into a morphed digital image.

### CLAIM OF PRIORITY

This application claims priority to United States Provisional Ser. No. 63/398,687, filed on Aug. 17, 2022, and titled METHOD AND SYSTEM OF RENDERING A 3D IMAGE FOR AUTOMATED EAR MORPHING. This provisional application is hereby incorporated by reference in its entirety.

### BACKGROUND

Aesthetic medicine and other cosmetic treatments are increasing in popularity. Treatments in this area can be permanent. Accordingly, patients often wish to view simulations of the final outcome. Patients also prefer to be able select from a set of possible outcomes. Consequently, various facial morphing methods are used to provide simulated outcomes. However, these methods may use 3D model morphing and often require high-levels of computer processing power and specialized algorithms to adequately model each individual patient's face. These may only be available at a cosmetic-treatment doctor's office. However, patients may wish to try various options on their faces prior to visiting the cosmetic-treatment doctor. Accordingly, improvements to methods of automated facial morphing for eyebrow hair and face color detection are desired.

### SUMMARY OF THE INVENTION

In one aspect, a computerized method useful for rendering a 3D image for automated ear morphing comprising: obtaining a face image, wherein the face image comprises a digital image of a view of a user's ears; detecting whether an ear in the digital image of a view of a user's ears is covered or not covered with a classifier; annotating a data side images of the digital image of the view of a user's ears; building a model to detect the ear beginning with a plurality of plurality of 2D landmarks of the user in the digital image; transferring the plurality of 2D landmarks of the user to a 3D model of the user; using a FLAME functionality to fit on the ear to the 3D model of the user; and morphing the ears into a morphed digital image.

### BRIEF DESCRIPTION OF THE DRAWINGS

The present application can be best understood by reference to the following description taken in conjunction with the accompanying figures, in which like parts may be referred to by like numerals.

FIG. 1 illustrates an example process for rendering a 3D image for automated facial morphing, according to some embodiments.

FIG. 2 illustrates an example process for analyze a set of image obtained for rendering a 3D facial image of a user, according to some embodiments.

FIGS. 3-8 illustrate a set of example post scan digital images to be utilized by process for generating a 3D model of a user's face.

FIG. 9 shows an example set of digital images obtained from a scan of the user's face, according to some embodiments.

FIG. 10 illustrates an example digital image of a texture map, according to some embodiments. The texture map is generated from the combination of three images that are then flattened out.

FIG. 11 schematically depicts an example process for automated facial morphing, according to some embodiments.

FIG. 12 illustrates an example process for facial landmark detection, according to some embodiments.

FIG. 13 illustrates an example process for removing acne effects from a digital image of a user, according to some embodiments.

FIG. 14 illustrates an example process for smoothing skin effects in a digital image, according to some embodiments.

FIG. 15 illustrates an example multi-pass ICP registration process, according to some embodiments.

FIG. 16 illustrates an example multi-pass ICP, according to some embodiments.

FIG. 17 illustrates an example set of comparisons among a set of ICP processes, according to some embodiments.

FIG. 18 illustrate an example process for 3D ear image morphing, according to some embodiments.

FIG. 19 illustrates an example pair of images showing ear points, according to some embodiments.

FIG. 20 illustrates an example images showing FLAME fitting on ears, according to some embodiments.

FIG. 21 illustrates an example images fitting FLAME with the 31 landmarks, according to some embodiments.

FIG. 23 illustrates an example image showing morphing of an image of the ears, according to some embodiments.

FIG. 24 illustrates an example image showing reduction in the size of an image of ears, according to some embodiments.

The Figures described above are a representative set and are not an exhaustive with respect to embodying the invention.

### DESCRIPTION

Disclosed are a system, method, and article of manufacture for rendering a 3D image for automated facial morphing. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

ARKit® is an API tool for developers working on virtual reality and augmented reality applications. The ARKit tool can accurately map a surrounding or object using SLAM (Simultaneous Localization and Mapping). Third-party developers can use ARKit to build augmented reality applications, leveraging a mobile device's camera, CPU, GPU, and motion sensors. ARKit can provide a face mesh showing automatic estimation of the real-world directional lighting environment. It is noted that in other embodiments, other relevant tools can be used in lieu of ARKit.

Computer vision is an interdisciplinary field that deals with how computers can be made for gaining high-level understanding from digital images or videos. From the perspective of engineering, it seeks to automate tasks that the human visual system can do.

Dlib is a general-purpose cross-platform software library written in the programming language C++.

Edge detection includes a variety of mathematical methods that aim at identifying points in a digital image at which the image brightness changes sharply or, more formally, has discontinuities.

FLAME can be a finishing software provide effective tools for 3D compositing, visual effects, and editorial finishing. FLAME can be used for compositing, advanced graphics, color correction, etc.

Image stitching can include the process of combining multiple photographic images with overlapping fields of view to produce a segmented panorama or high-resolution image.

Iterative closest path (ICP) can be an algorithm employed to minimize the difference between two clouds of points. ICP can implement computationally accurate and efficient registration of 3-D shapes which includes free form curves and surface. ICP is often used to reconstruct 3D surfaces from various scans, etc.

Low-pass filter (LPF) is a filter that passes signals with a frequency lower than a selected cutoff frequency and attenuates signals with frequencies higher than the cutoff frequency. The exact frequency response of the filter depends on the filter design.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Marching cubes is a computer graphics algorithm for extracting a polygonal mesh of an isosurface from a three-dimensional discrete scalar field (e.g. a voxel).

OpenCV (Open Source Computer Vision) is a library of programming functions mainly aimed at real-time computer vision.

Open Graphics Library (OpenGL) is a cross-language, cross-platform application programming interface (API) for rendering 2D and 3D vector graphics.

Otoplasty can be a procedure that is performed for protruding or large ears It corrects and pin the ear back, so it has a normal shape and contour.

3D computer graphics can be computer graphics that use a three-dimensional representation of geometric data.

Rendering or image synthesis is the automatic process of generating a photorealistic or non-photorealistic image from a 2D or 3D model (or models in what collectively could be called a scene file) by means of computer programs.

Signed distance function of a set Q in a metric space determines the distance of a given point x from the boundary of Q, with the sign determined by whether x is in Q. The function has positive values at points x inside Q, it decreases in value as x approaches the boundary of Q where the signed distance function is zero, and it takes negative values outside of Q.

Texture mapping can be a method for defining high frequency detail, surface texture, or color information on a computer-generated graphic or 3D model.

Truncated signed distance function (TSDF) can be a volumetric scene representation that enables for integration of multiple depth images taken from different viewpoints.

Voxel represents a value on a regular grid in three-dimensional space. A voxel can be used by a rendering system to infer the position of a voxel based upon its position relative to other voxels (e.g., its position in the data structure that makes up a single volumetric image).

### Example Method for Generating a 3D Model of a User's Face

Example embodiments of an automated facial morphing application can be used enable plastic surgery candidates to view digital renderings of images that the candidate will appear like after cosmetic surgery. The automated facial morphing application can ‘automate’ the candidate's experience by evaluating the candidate's face and automatically applying facial elements such as a preferred eyebrow, a preferred nose, etc. It is noted that previously facial morphing system were not automated and limited to expensive systems available in a doctor's office. In contrast, the automated facial morphing application can implement this facial morphing experience to a mobile device and can be managed by the plastic surgery candidate without professional assistance. The automated facial morphing application can be used to preview facial morphing in anticipation of, inter alia: facelifts, rhinoplasties, lip augmentations, eyebrow adjustments, otoplasty, etc. The automated facial morphing application can identify facial features by extracting landmarks, or features, from an image of the subject's face. It is noted that facial morphing can include ear morphing. For example, an algorithm may analyze the relative position, size, and/or shape of the eyes, nose, cheekbones, and jaw.

In one example, the mobile device system can include a facial recognition camera system. This can be a depth-sensing camera system. The depth-sensing camera system can include a dot projector. The dot projector can project n-number of dots (e.g. 30,000 dots, etc.) onto a user's face. The depth-sensing camera system can include an infrared camera that reads the dot pattern and captures an infrared digital image. The digital image of the dots can be used to build a facial map of the user. The depth-sensing camera system can include a flood illuminator. The flood illuminator can provide an infrared projection light source.

In one example, the depth-sensing camera system can be a TRUEDEPTH® camera (e.g. as used in an IPHONE® mobile device, etc.). In one example, the TrueDepth camera can be 7-megapixel and have an f/2.2 aperture. The mobile device system can implement face detection and HDR.

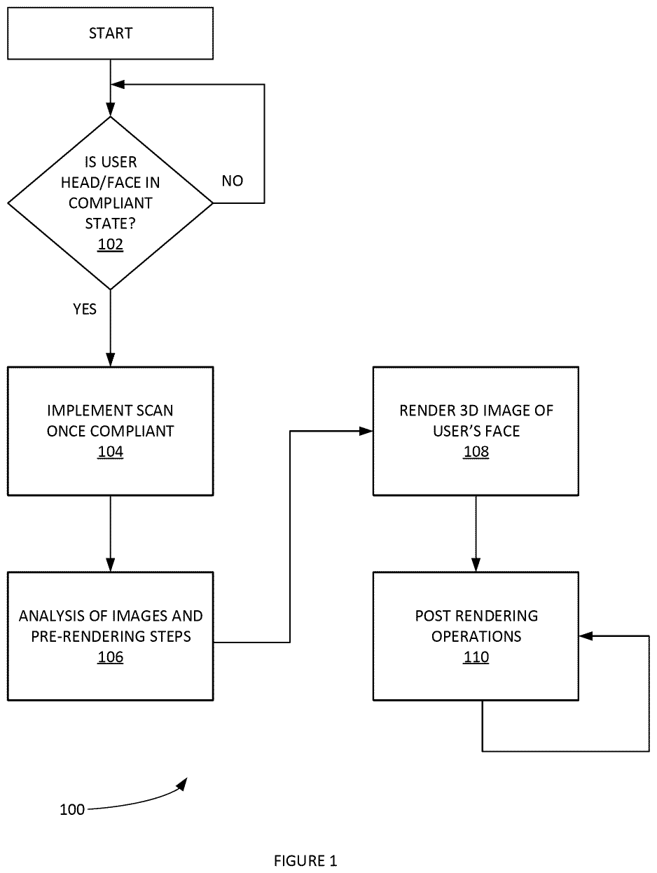

FIG. 1 illustrates an example process 100 for 3D morphable image of a user's face, according to some embodiments. In step 102, process 100 can determine whether the user's head/face is in a compliant state? For example, process 100 can determine if the user's face is straight (e.g. the central axis of the user's face is perpendicular to a horizonal plane, etc.). Parameters for a compliant state can include, inter alia: user is looking straight ahead, no hair in user's face, user not smiling, etc. Process 100 can push messages (e.g. text messages with an application, voice-based instructions, haptic feedback, etc.) that instruct the user to, inter alia: “look straight ahead”, “pull hair back”, “don't smile”, etc. Process 100 can repeat the instructions until the user is in a compliant state.

Process 100 can proceed to step 104. In step 104, process 100 can implement a scan of the user's face. FIG. 9 infra shows an example set of digital images obtained from a scan of the user's face, according to some embodiments. The user can place their head in the various positions shown. For example, a user can look to the right, to the center, to the left and the upward. In other example embodiments, other positions and/or sequences of head movement can be utilized. During the movement of the user's head, process 100 can take a series of around 75 images with corresponding depth information (e.g. using from a TrueDepth camera systems and/or similar camera system such as described supra, etc.). The mobile device implementing process 100 can obtain the depth information of the various digital images. Process 100 can obtain a series of digital RGB photos in bursts. The digital RGB photos can be combined with the depth information from depth-sensing camera system. It is noted that in some embodiments, a digital video is not obtained, but rather a series of digital-image frames and the depth information corresponding to each respective digital-image frame.

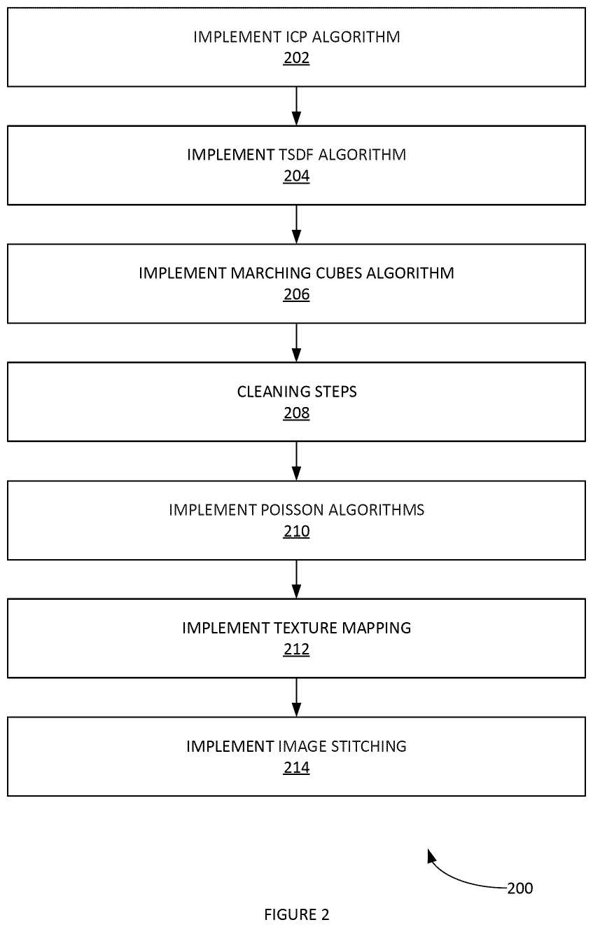

Process 100 can then proceed to step 106. In step 106, process 100 can implement analysis of digital images and various pre-rendering steps. FIG. 2 illustrates an example process 200 for analyze a set of images obtained for rendering a 3D facial image of a user, according to some embodiments. Process 200 can be used for processing the digital images post scan but pre-render of the 3D model.

In step 202, process 200 can implement an ICP algorithm (e.g. an OpenCV ICP algorithm, etc.). Process 200 can optimize between a first view and the other views. The points can be chosen by using ARKit face mask to ensure that they are only located on the user's face. The inputs can include, inter alia: depth image (e.g. a file path), RGB Image (File path), ARKit Facemask (e.g. file path), etc. The ICP stitches together the points from the facemask (e.g. the facemask sits on a user's face) and the correlated images. The outputs of step 202 can include the transformations, etc.

In step 204, process 200 can implement a TSDF algorithm on the output of step 202. The TSDF algorithm represents the points in a regularized voxel grid. The inputs in step 204 include, inter alia: transformations, depth image. The TSDF algorithm can continue to blend and match together all the digital images. For example, meshes with triangles and vertices of the output of the ICP step 202 can be blended and matched in one uniform object. The output of step 204 includes a voxel representation (e.g. a 1-D array of voxels).

The remaining steps, as shown infra, provide cleaning steps to clear out floating vertices (e.g. an artifact that is outside of the face), fill in holes between meshed together images, implement texture mapping, image stitching (e.g. obtain texture map of the three images and combine and image stitch this into a single image), etc.

In step 206, process 200 can implement a marching cubes algorithm. Step 206 obtains a voxel representation (e.g. 1-D array of voxels). Process 200 can create a 3D mesh out of per-voxel values provided by the TSDF inputs. Step 206 outputs a mesh representation (e.g. triangles and vertices).

In step 208, process 200 implements cleaning algorithms. Step 208 obtains the Mesh Outputs of step 206. Process 200 then cleans the floating vertices and triangles. Process 200 can clean various patches on the back of the head. Process 200 can clean around patches neck. Step 208 can output a mesh (e.g. scattered points with a normal per point).

In step 210, process 200 can implement various Poisson algorithms on the mesh output of step 208. Process 200 uses the Poisson algorithm to fill in the holes of the mesh. The output of step 210 can be a reconstructed mesh that is passed to step 212.

In step 212, process 200 can implement texture mapping. Process 200 can use a cylinder to map the texture constructed by three images coming from the three different views. The inputs of step 212 can be the mesh output of step 210, three RGB images and the transformation matrices calculated through ICP algorithm. Step 212 can output a texture (e.g. saved as “pixels.png” in a document directory of the mobile-device application). Step 212 can also create a “labels.png” as a mask representation that illustrates each piece of the image comes from a different source.

In step 214, process 200 can implement image stitching. Process 200 can stitch images with different lighting to remove seams. Step 214 can receive the single image consists of multiple images with different lighting. A label image that consists of one specific label color for each piece of image that comes from different lighting. Step 214 can output one image with consistent lighting over all pieces (e.g. “texture.png”).

Returning to process 100, the output of (e.g. the output of process 200) can be provided in step 108. In step 108, process 100 can render the 3D image user's face. The 3D model can be rendered using a custom library with an internal SDK as well. A hardware-accelerated 3D graphic and compute shader application programming interface (API) can be used to render it (e.g. METAL®, etc.). The rendering can be displayed in a mobile-device application display.

In step 110 process 100 can implement post rendering operations (e.g. automated and/or manual facial morphing processes, etc.). Example automated facial morphing processes, can include, inter alia: ability to segregate face into regions for injectables; under-eye bag removal; blepharoplasty morphing; jawline reduction; beard detection; autocorrection of crooked noses; etc. Additional processes that can be implemented with the 3D model include processes 1100-1400 discussed infra.

### Example Digital Images

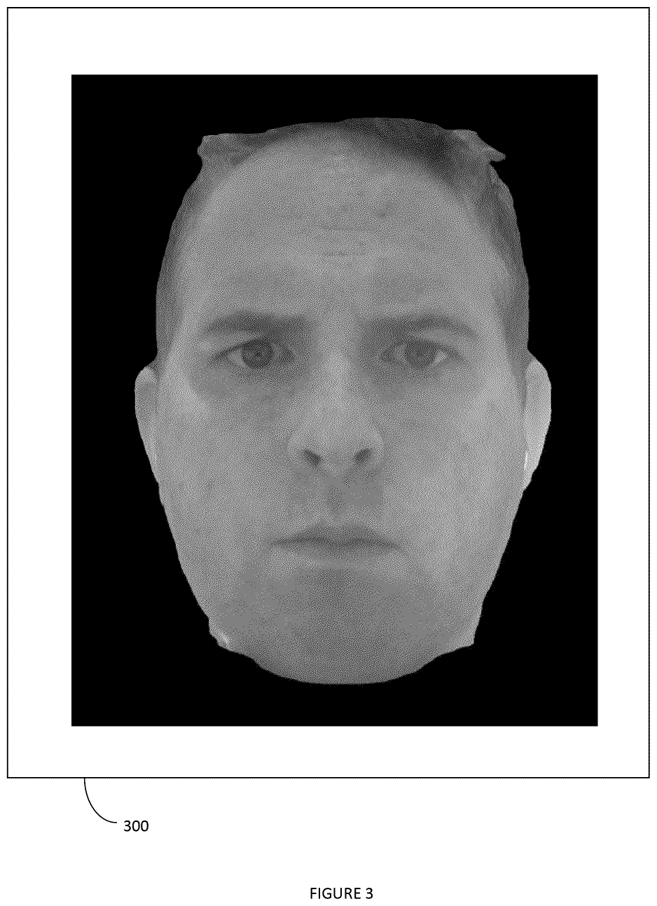

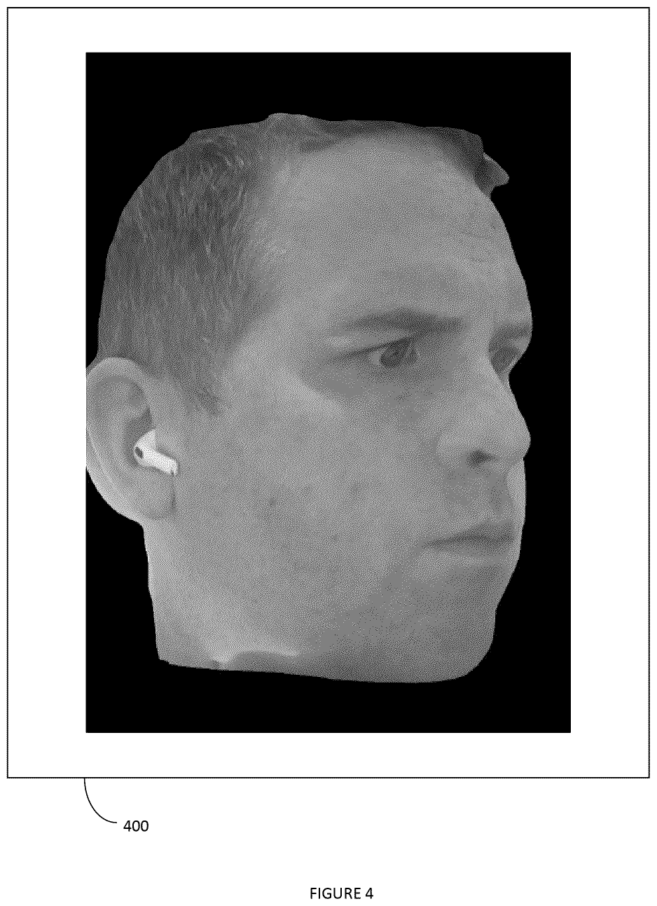

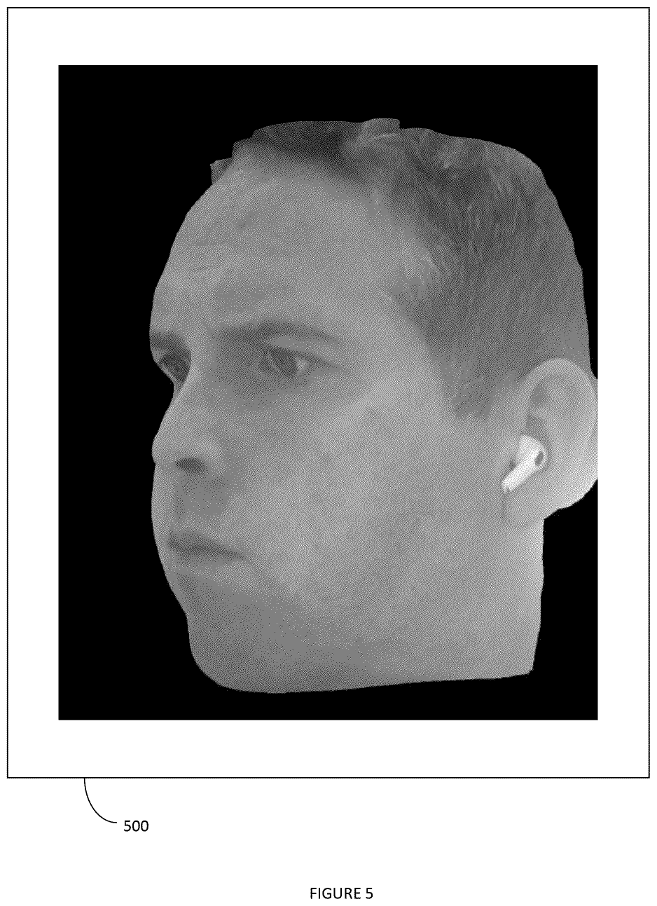

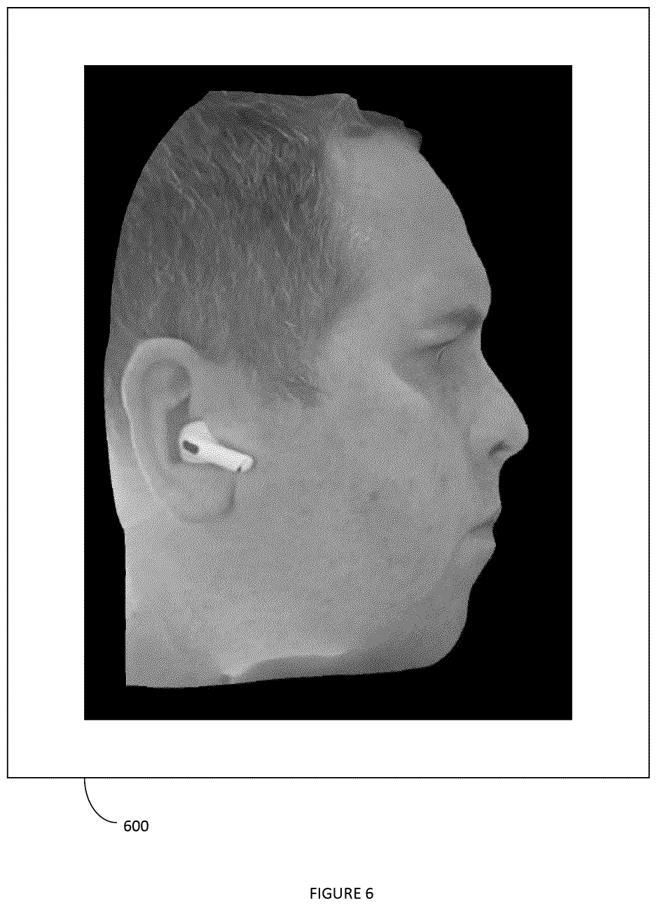

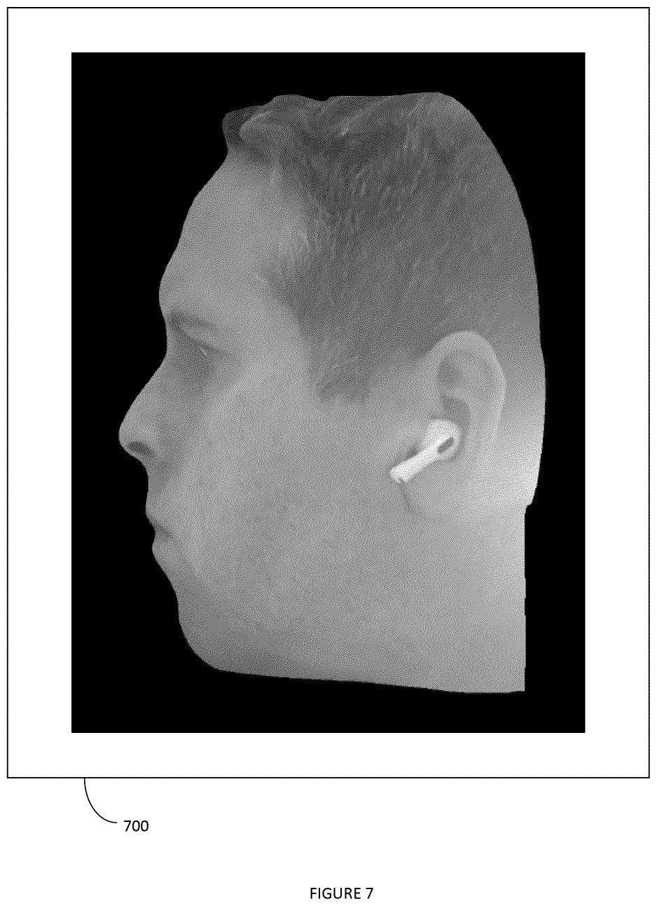

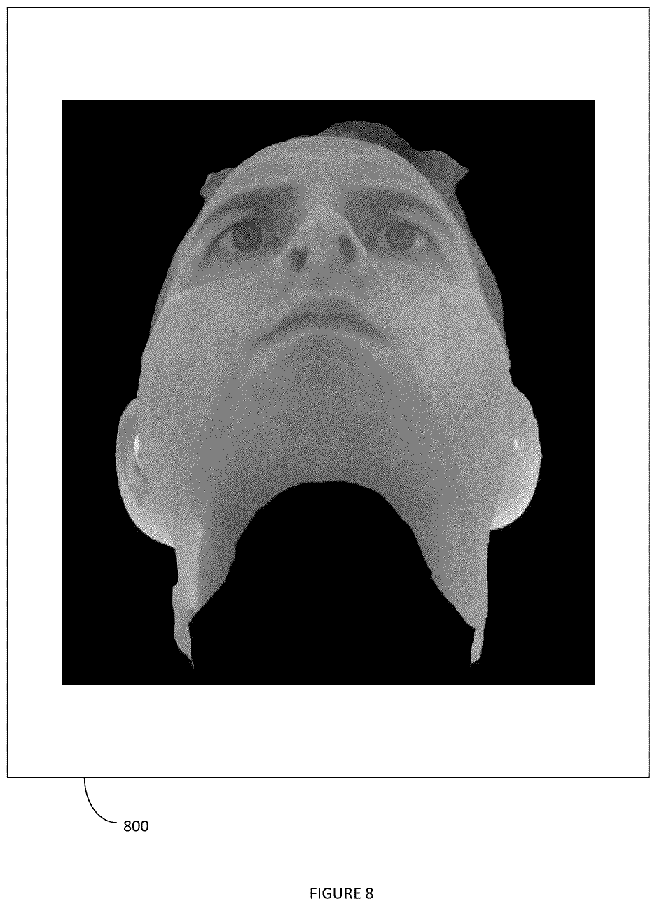

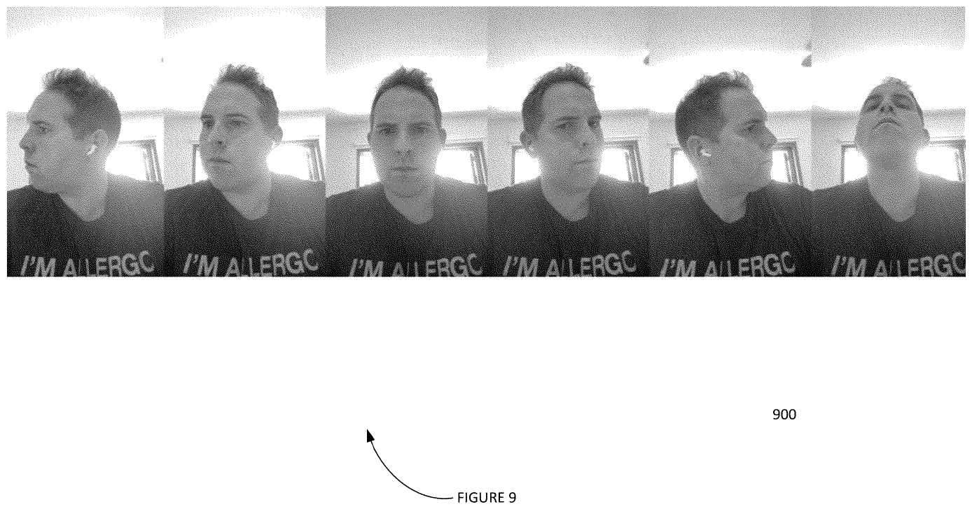

FIGS. 3-8 illustrate a set of example post scan digital images 800 to be utilized by process 200 for generating a 3D model of a user's face. The set of example post scan digital images can be generated from set of digital images 900.

FIG. 9 shows an example set of digital images 900 obtained from a scan of the user's face, according to some embodiments.

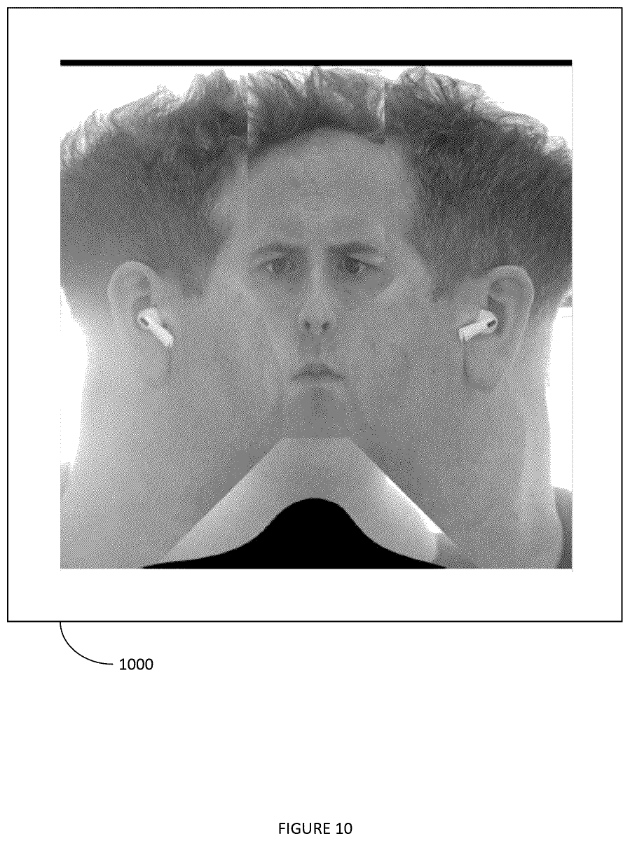

FIG. 10 illustrates an example digital image of a texture map 1000, according to some embodiments. The texture map is generated from the combination of three images that are then flattened out.

### Additional Example Processes

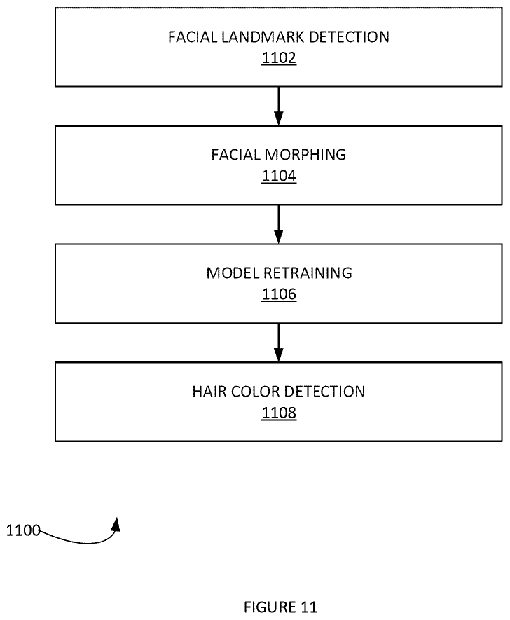

FIGS. 11-14 illustrate additional example automated facial morphing processes according to some embodiments.

FIG. 11 schematically depicts an example process 1100 for automated facial morphing, according to some embodiments. More specifically, in step 1102, process 1100 can implement facial landmark detection. In step 1104, process 1100 can implement facial morphing. In step 1106, process 1100 can implement model retraining. In step 1108, process 1100 can implement hair color detection.

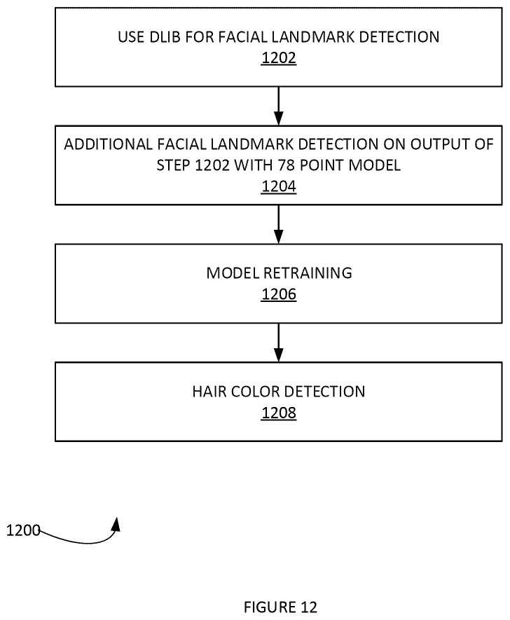

FIG. 12 illustrates an example process 1200 for facial landmark detection, according to some embodiments. It is noted that facial landmark detection is different from facial recognition in the sense that landmark detection is the process of identifying facial features on a face. In one example, process 1100 can use various open source tool (e.g. Dlib, etc.) to do an initial phase of facial landmark detection. However, because of the level of detail that is to be obtained around a specified set of the features, such as: eyebrow, nose, and lip detection. Process 1200 can generate an n-point model (e.g. seventy-eight (78) point model, eighty-five (85) point model, etc.) that provides a higher resolution on the eyebrow in particular.

More specifically, in step 1202, process 1200 can use Dlib for facial landmark detection. In step 1204, process 1200 can use additional facial landmark detection on output of step 1202 with a higher resolution seventy-eight (78) point model that focuses on the eyebrow region. In step 1206, process 1200 can implement hair/eyelid detection using OpenCV as well as doing fast edge detection using a structured forest model. In step 1208, process 1200 can compensate for poor lighting/face angles using an OpenCV heuristics mechanism. It is noted that in some example embodiments another computer vision library can be used in lieu of OpenCV. Additionally, in some example embodiments, an n-point model other than a seventy-eight (78) point model can be utilized.

Returning to process 1100. Process 1100 can implement facial morphing by morphing the following areas of the face: skin, lips, eyebrows, nose, etc. These morphs can be implemented using OpenGL on an iOS device in one example.

Process 1100 can implement model retraining. Process 1100 can feed production images back into the model. This can enable process 1100 to retrain the model periodically and improve the detection of facial landmark features on a wider variety of user segments (e.g. various ages, ethnicities, lighting, etc.). It is noted that process 1100 can be modified to detect if the user is we

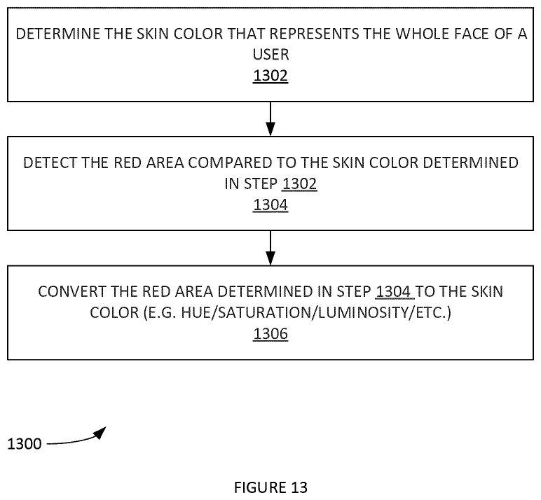

FIG. 13 illustrates an example process 1300 for removing acne effects from a digital image of a user, according to some embodiments. Process 1300 can be used to remove the redness in a digital image of a user's face that is associated with acne.

In step 1302, process 1300 can determine the skin color that represents the whole face. IN step 1304, process 1300 can detect the red area compare to the skin color. In step 1306, process 1300 can convert the area of step 1304 to the skin color (e.g. same hue/sat/lum/etc.).

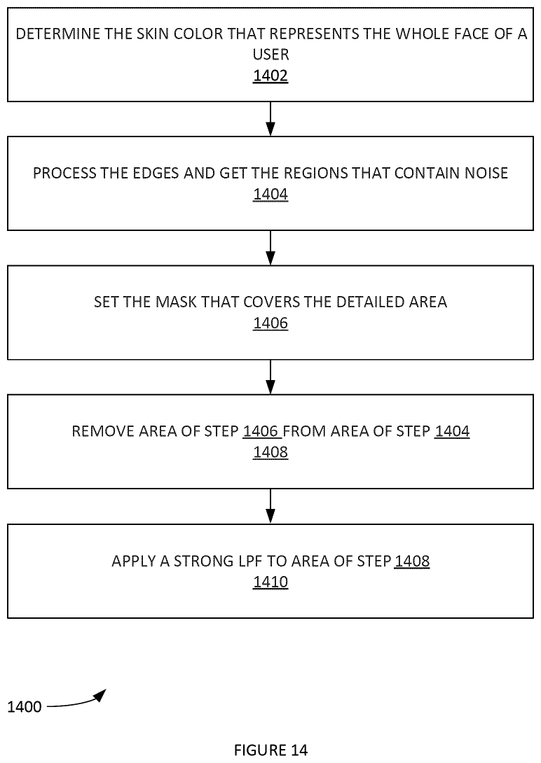

FIG. 14 illustrates an example process 1400 for smoothing skin effects in a digital image, according to some embodiments. Process 1400 can be used to smooth skin effects of a user's face in a digital image.

In step 1402, process 1400 can detect edges from a black and white digital image. The black and white digital image can be of a user's face. In step 1404, process 1400 can process the edges and get the regions that contain noise. In step 1406, process 1400 can set the mask that covers the detailed area (e.g. eyes, nose, ears, and mouth). In step 1408, process 1400 can remove area of step 1406 from area of step 1404. In step 1410, process 1400 can apply a strong LPF to the area of step 1408.

### Multipass ICP Methods

Disclosed are methods and systems for multi-pass ICP registration. A method that we propose to improve the accuracy of registration for 3D point-set captured by AR (Augmented Reality) face tracking APIs. It is noted that, for face tracking APIs, such as ARKit, misalignment can occur when implementing the process provided supra. This can occur when the face mask is not aligned with face in image space and/or 3D space the face mask is aligned with the face in image space, but shifted away from the face in 3D space. For example, ARKit may sometimes loose tracking while the user is in motion and misalignment may occur.

Accordingly, when given two frames of point clouds, they can be transformed back to the canonical space by using the transformation matrix of their corresponding face masks. When this is done, the final point clouds may not align with each other. With large misalignment, if the point-to-plane ICP is performed to register the two-point clouds together, it can lead to a failure when the registration method critically relies on a rough alignment as initialization.

One solution can be to apply a 2-step ICP method. Instead of registering two-point clouds directly, the 2-step ICP method can first register each point cloud to its corresponding face mask to correct the misalignment. The initial poses of the two-point clouds can roughly/substantially aligned.

The 2-step ICP method can then perform the point cloud-to-point cloud ICP. In this step, another ICP registration can be performed on the two corrected point clouds.

It is noted however, the point clouds are registered to the face mask, one is correctly registered to the face mask, the other one face masked may be a failed registration.

Accordingly, the final two corrected points clouds may still have large misalignment. This may lead to an ICP failure.

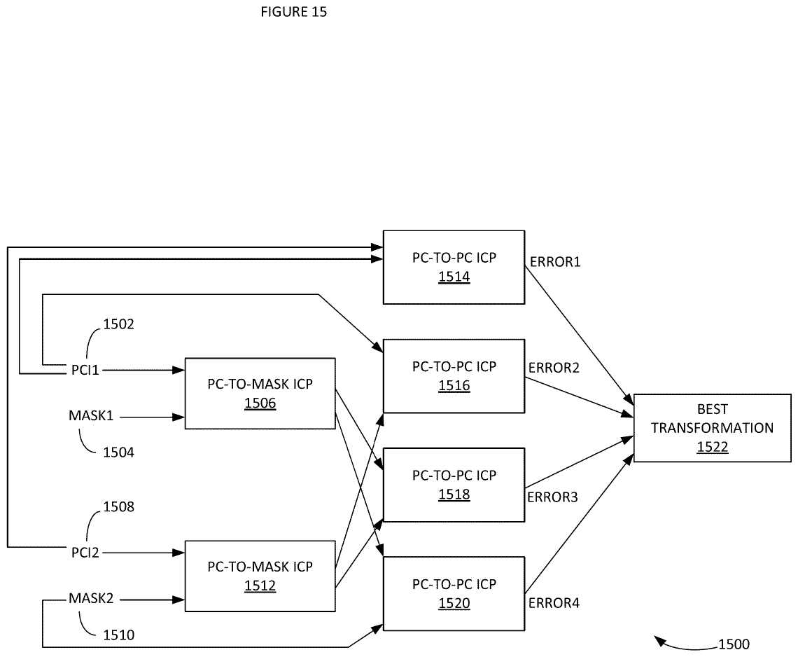

FIG. 15 illustrates an example multi-pass ICP process 1500, according to some embodiments. Multi-pass ICP process 1500 can utilized a first point cloud (PC1) 1502 and a second point cloud (PC2) 1508. Multi-pass ICP process 1500 can include face mask 1504 (mask1) and face mask 1510 (mask2). These can be ARKit facemasks.

Process 1500 can perform a PC-to-mask ICP operation in step 1506. Step 1506 can utilize PC1 1502 and face mask 1504. The output of step 1506 can be provided to step 1518. In step 1518, process 1500 performs a PC-to-PC ICP on the output of step 1506 and face mask 1504. The output of step 1506 can be provided to step 1520. Step 1518 can output error 3 as a measure of its ICP registration accuracy.

In step 1520, process 1500 can perform PC-to-PC ICP on the output of step 1506 and face mask 1510. Step 1520 can output error 4 as a measure of its ICP registration accuracy.

In step 1512, process 1500 can perform PC-to-mask ICP on PC2 1508 and face mask 1510. PC1 1502 and the output of PC-to-mask ICP step 1512 can be provided to PC-to-PC ICP in step 1516. Step 1516 can output error 2 as a measures its ICP registration accuracy.

In step 1514, process 1500 can perform PC-to-mask ICP on PC1 1502 and PC2 1508. Step 1514 can output error 1 as a measure of its ICP registration accuracy. In step, process 1500 can select which transformation of error 1, error 2, error 3 or error 4 that has the lowest error.

In another example, process 1500 can implement multi-pass ICP. Since the registration method relies on the initial poses of the two input point clouds, here process 1500 can include four (4) passes with different initial poses of the two-point clouds as the inputs for the registration. In a first pass, a 1-step ICP is implemented (e.g. corresponding to step 1514 supra, etc.) to register the two-point clouds directly.

In a second pass, parallel 2-step ICPs are performed (e.g. corresponding to steps 1506 and 1512 supra, etc.). The 2-step ICPs can register each point cloud to its corresponding face mask to correct the misalignment. Then, the 2-step ICPs can perform the point cloud-to-point cloud ICP. Additionally, the 2-step ICPs can include a second ICP pass (e.g. step 1518 supra, etc.).

After these 2-step ICPs, process 1500 can implement two more ICP passes (e.g. in steps 1516 and 1520, etc.). On additional ICP pass (e.g. step 1516, etc.) can register the point cloud 1 with corrected point cloud 2. The other additional ICP pass (e.g. step 1520, etc.) can register the point cloud 2 with corrected point cloud 1. Each pass can output an error that measures the registration accuracy. The smaller the error, the better the ICP registration.

Finally, process 1500 selects the transformation with the lowest error as the best transformation to register the two-point clouds (e.g. PC1 1502 and PC2 1508).

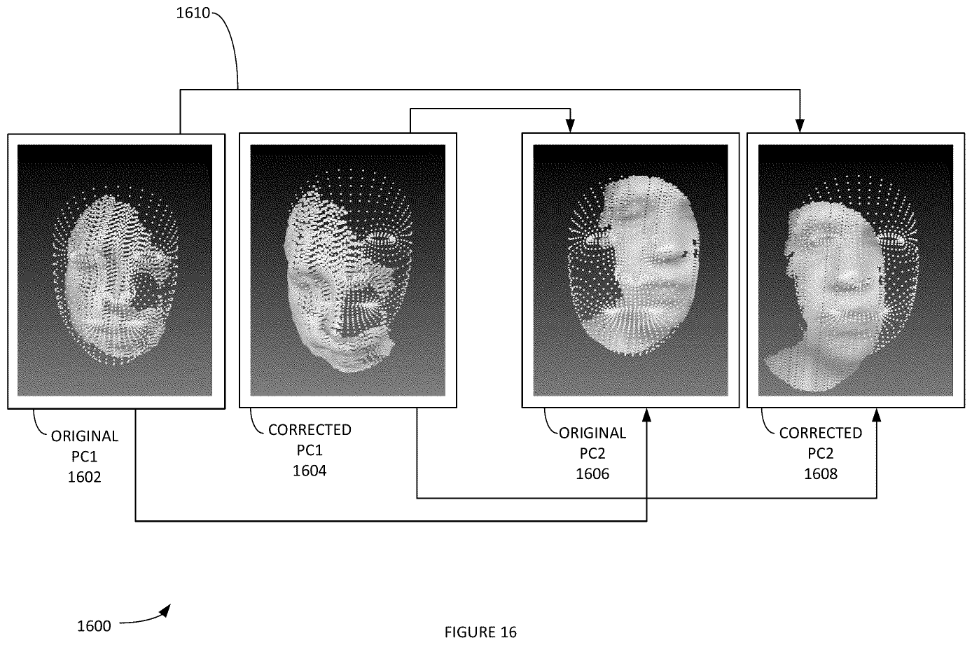

FIG. 16 illustrates an example multi-pass ICP 1600, according to some embodiments. As shown, the pass that registers the original point cloud 1 1602 to corrected point cloud 2 1608 has the lowest error and has the best transformation to register the two-point clouds (e.g. as opposed to the other transformation for corrected PC1 1604 original PC2 1606, etc.).

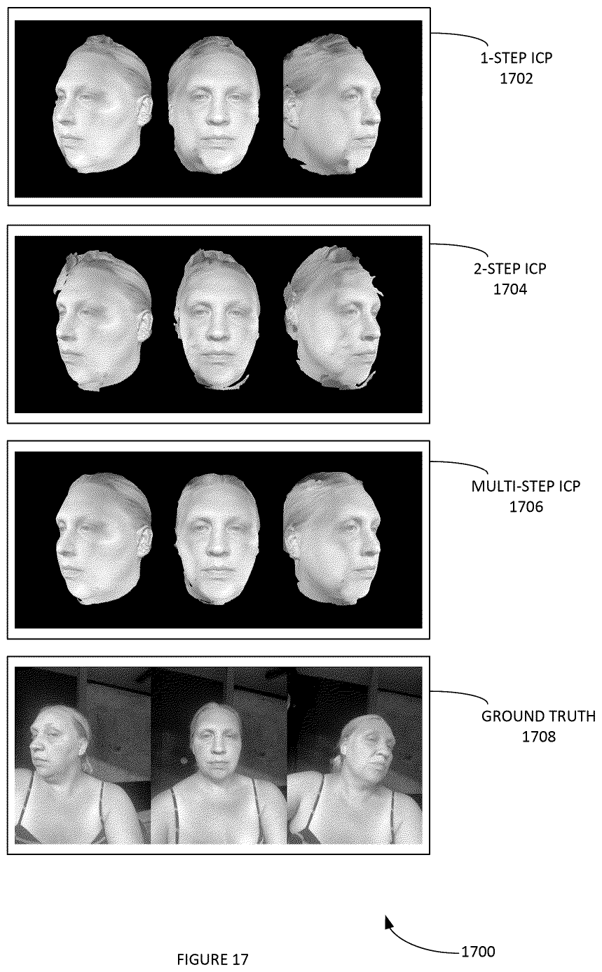

FIG. 17 illustrates an example set of comparisons 1700 among a set of ICP processes, according to some embodiments. Set of comparisons 1700 includes digital images showing the outputs of the various ICP registrations processes. These include: 1-step ICP 1702,2-step ICP 1704, multi-step ICP 1706, and ground truth 1708. As shown, the multi-pass ICP 1706 solves the misalignment compared to other methods and is the closest to the ground truth.

### Otoplasty with Flame Embodiments

It is noted that otoplasty denotes the surgical and non-surgical procedures for correcting the deformities and defects of the pinna (e.g. external ear), and for reconstructing a defective, and/or deformed, or absent external ear, consequent to congenital conditions, trauma, etc. An otoplasty procedure can correct the defect and/or deformity by creating an external ear that is of natural proportions, contour, and appearance, usually achieved by the reshaping, the moving, and the augmenting of the cartilaginous support framework of the pinna. Additional information regarding an otoplasty is provided in Appendix A.

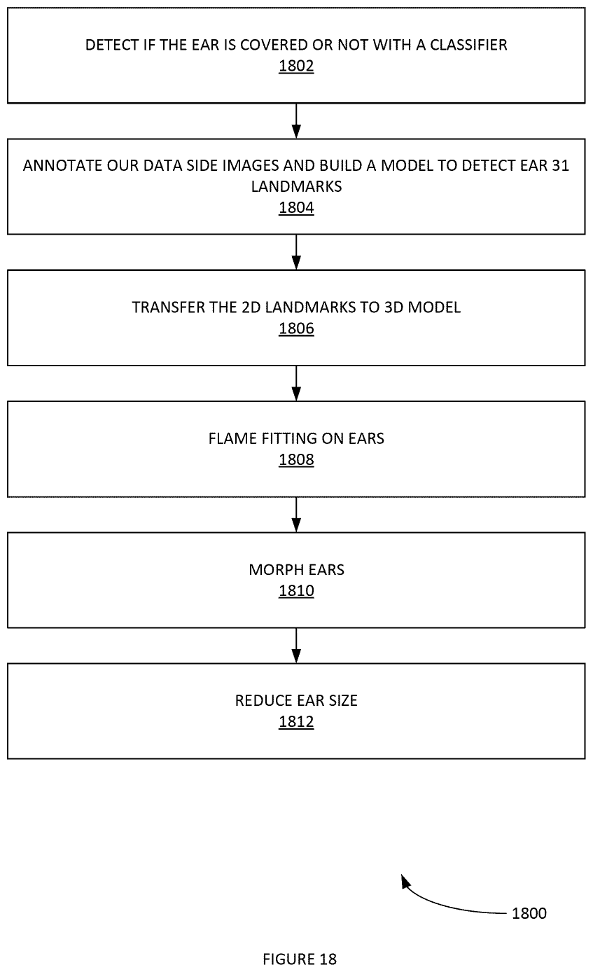

FIG. 18 illustrate an example process for 3D ear image morphing, according to some embodiments. Process 1800 can be to reduce the Conchal bowl in a morphed digital image. Process 1800 can be to shape the antihelix in a morphed digital image. Process 1800 can be to create a NICE triangle in a morphed digital image. Process 1800 can be to reduce the overall size of the ear in a morphed digital image. Process 1800 can be to detect and angle on the ear and pin them back in a morphed digital image.

More specifically, in step 1802, process 1800 can detect if the ear is covered or not with a classifier. In step 1804, process 1800 can annotate the data side images and build a model to detect ear. This step can use thirty-one (31) landmarks.

In step 1806 process 1800 can transfer the 2D landmarks to a 3D model. In step 1808, process 1800 can use FLAME (and/or a similar type of functionality) to fit on ears to the 3D model. In step 1810, process 1800 can morph the ears. In step 1812, process 1800 can reduce ear size.

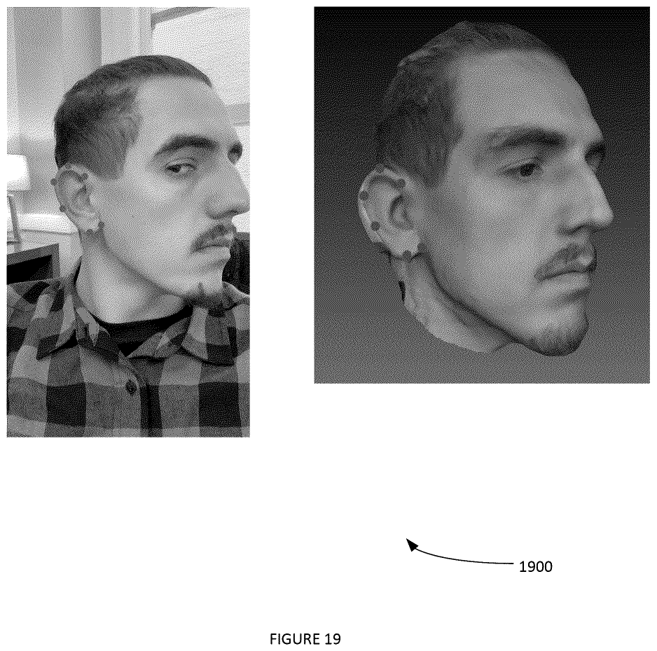

FIG. 19 illustrates an example pair of images 1900 showing ear points, according to some embodiments.

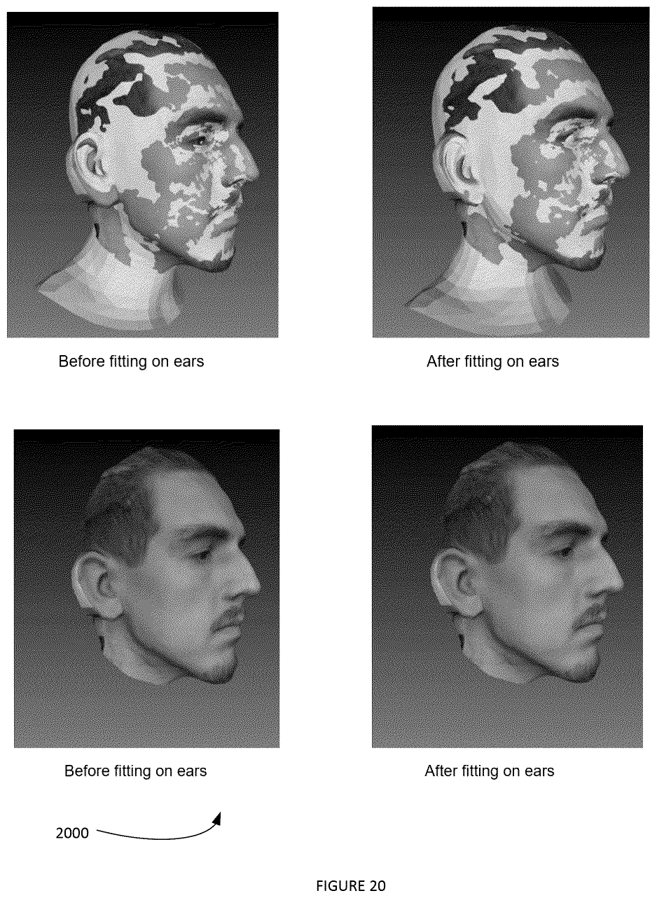

FIG. 20 illustrates an example images 2000 showing FLAME fitting on ears, according to some embodiments.

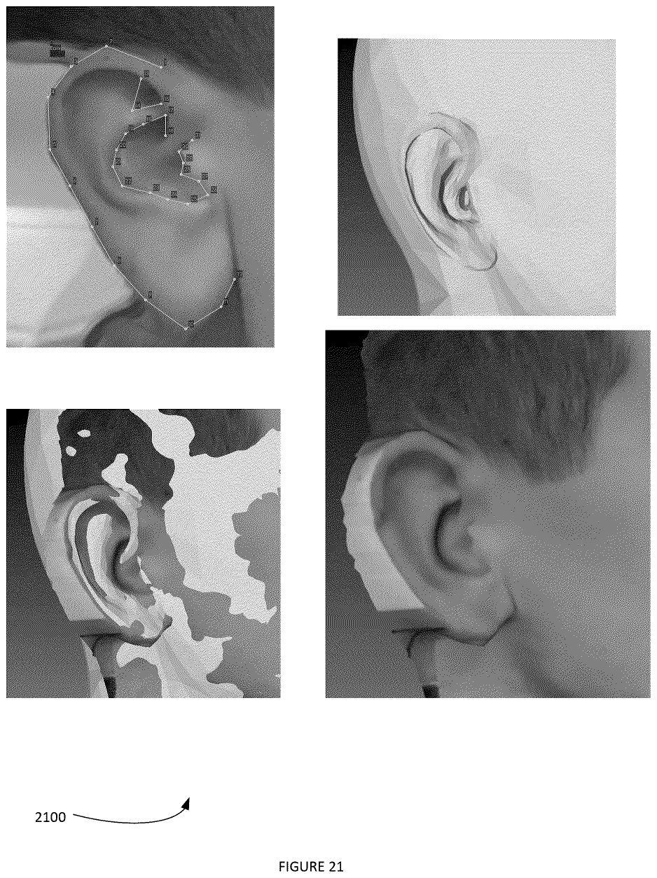

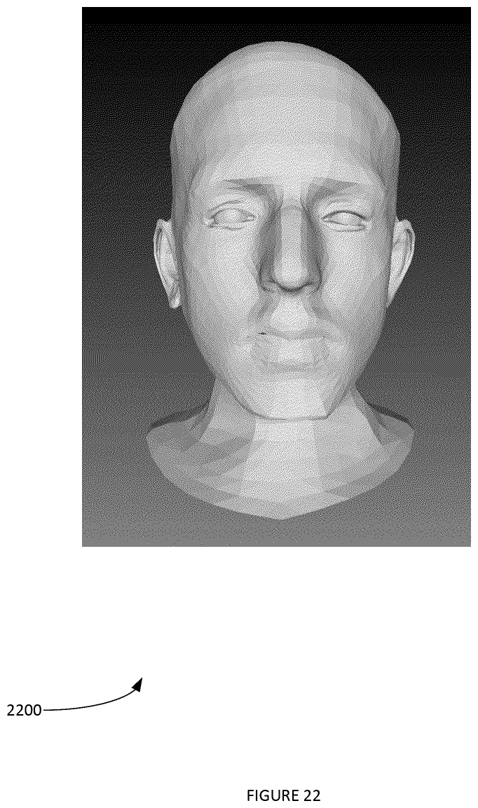

FIG. 21 illustrates an example images 2100 fitting FLAME with the 31 landmarks, according to some embodiments.

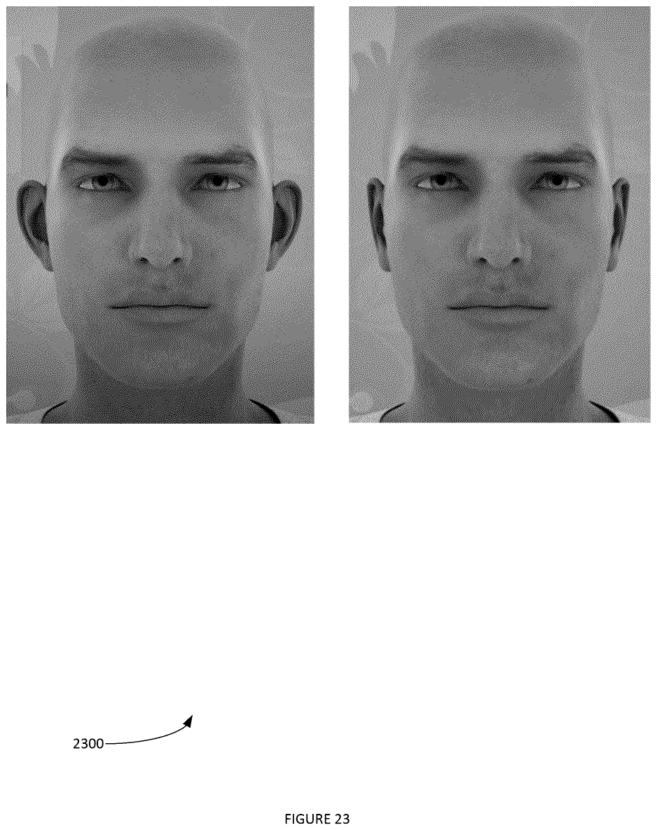

FIG. 23 illustrates an example image 2300 showing morphing of an image of the ears, according to some embodiments.

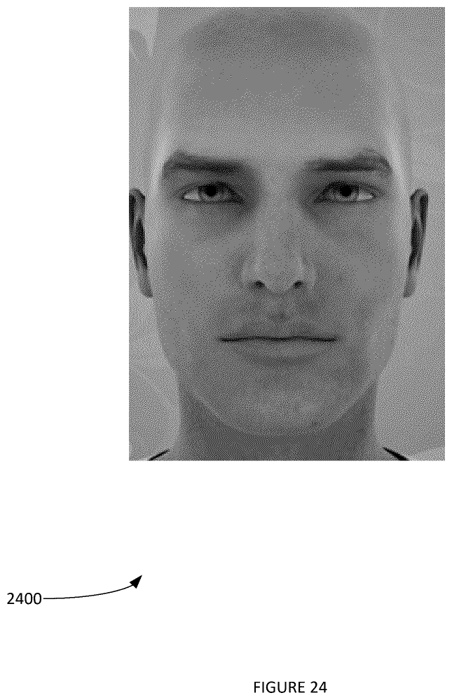

FIG. 24 illustrates an example image 2400 showing reduction in the size of an image of ears, according to some embodiments.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations).

Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method useful for rendering a 3D image for automated ear morphing comprising:
obtaining a face image, wherein the face image comprises a digital image of a view of a user's ears;
detecting whether an ear in the digital image of a view of a user's ears is covered or not covered with a classifier;
annotating a data side images of the digital image of the view of a user's ears;
building a model to detect the ear beginning with a plurality of plurality of 2D landmarks of the user in the digital image;
transferring the plurality of 2D landmarks of the user to a 3D model of the user;
using a FLAME functionality to fit on the ear to the 3D model of the user; and
morphing the ears into a morphed digital image.

2. The computerized method of claim 1,
reducing an ear size of the ear.

3. The computerized method of claim 2, wherein the building a model to detect the ear uses thirty-one (31) landmarks.

4. The computerized method of claim 1 further comprising:
reducing a Conchal bowl in the morphed digital image.

5. The computerized method of claim 1 further comprising:
shaping an antihelix in the morphed digital image.

6. The computerized method of claim 1 further comprising:
creating a NICE triangle in a morphed digital image.

7. The computerized method of claim 1 further comprising:
creating a NICE triangle in the morphed digital image.

8. The computerized method of claim 1 further comprising:
reducing an overall size of the ear in the morphed digital image.

9. The computerized method of claim 1 further comprising:
detecting an angle on the ear.

10. The computerized method of claim 1 further comprising:
pining the ear back in the morphed digital image.
